(19) United States
(12) Patent Application Publication
(10) Pub. No.: US 2024/0409122 A1
(43) Pub. Date: Dec. 12, 2024

(54) METHOD FOR PLANNING A TRAJECTORY OF A DRIVING MANEUVER OF A MOTOR VEHICLE, COMPUTER PROGRAM PRODUCT, COMPUTER-READABLE STORAGE MEDIUM, AND VEHICLE

(71) Applicant: Continental Autonomous Mobility Germany GmbH, Ingolstadt (DE)

(72) Inventors: Michael Engelhorn, Frankfurt (DE); Maximilian Rieder, Hösbach (DE); Frank Edling, Schwalbach (DE)

(73) Assignee: Continental Autonomous Mobility Germany GmbH, Ingolstadt (DE)

(21) Appl. No.: 18/698,342

(22) PCT Filed: Sep. 21, 2022
(86) PCT No.: PCT/DE2022/200221

§ 371 Date: Apr. 3, 2024

(30) Foreign Application Priority Data
Oct. 4, 2021 (DE) 10 2021 211 164.5

(51) Int. Cl. B60W 60/00; B60W 30/182

(52) U.S. Cl. CPC B60W 60/001; B60W 30/182

(57) ABSTRACT

A method for planning a driving maneuver trajectory is disclosed. The method includes 1) evaluating a current driving situation; 2) ascertaining an adapted driving maneuver based on the evaluated driving situation; 3) calculating a number of working points of the trajectory on the basis of the evaluated driving situation and the ascertained driving maneuver; 4) discretizing the current surroundings information and/or vehicle information at each of the working points of the trajectory; 5) selecting and integrating relevant surroundings data for each working point based on domain-specific information; 6) linearizing the selected and integrated surroundings data; 7) using the linearized surroundings data to formulate a QP model; 8) solving the QP model by means of a QP solver; and 9) repeating 1) to 8) on the basis of a convergence of the solution, wherein upon repeating steps 1) to 8), the solution of the QP solver is taken into consideration.

### CROSS-REFERENCE TO RELATED APPLICATIONS

The present application is a National Stage Application under 35 U.S.C. § 371 of International Patent Application No. PCT/DE2022/200221 filed on Sep. 21, 2022, and claims priority from German Patent Application No. 10 2021 211 164.5 filed on Oct. 4, 2021, in the German Patent Office, the disclosures of which are herein incorporated by reference in their entireties.

### TECHNICAL FIELD

The invention relates to a method for planning a trajectory of a driving maneuver of a motor vehicle, a computer program product, a computer-readable storage medium, and a vehicle.

### BACKGROUND

Trajectory planning is one of the most important steps of vehicle automation. Even in a structured context such as highway driving, any scenarios which occur are complex, and planning is a non-trivial task.

Solving this problem by modeling in the form of an optimization leads to a non-linear problem. Hence, especially in terms of a limited timeframe, in which an in particular autonomously driving motor vehicle has to solve the problem, a resource-efficient algorithm is required in order to solve the problem reliably and within the fixed timeframe.

It is the task of non-linear general-purpose solvers to solve generic problems. Modeling by continual functions and mixed integers lacks the possibility of a heuristic appraisal which is necessary in order to solve the problem of the trajectory planning within the framework of the optimization.

The problem of “getting stuck” in local minima in the case of discrete decisions (mixed-integer problems) is widely described in the literature.

Nevertheless, the methods described in, and known from, the literature and the prior art are disadvantageous. There is a need, in particular in the case of complex driving scenarios, for an integrated trajectory planning algorithm which efficiently solves the entire non-linear problem in a single step.

Furthermore, for example in the case of a 2-step planning approach (1^{st} step: primitive sampling, 2^{nd} step SQP-based), the boundary conditions are merely adapted between the planning loops only, but not at each operating point.

Moreover, the methods which are already known only consider the separate lateral and longitudinal trajectory planning by numerical optimization methods. In this case, in a subsequent step, the two parts of the separate trajectories are combined in order to autonomously control a vehicle, which results in an increased (computational) outlay.

### SUMMARY

Proceeding herefrom, the object of the present disclosure is to specify a method, a computer program product, a computer-readable storage medium, and a vehicle, with the aid of which a trajectory is planned simultaneously with less outlay and in a more optimized manner.

According to the present disclosure, the object in terms of the method is achieved by the subject-matter of Claim 1. With respect to the computer program product, the object is achieved by the subject-matter of the alternative, independent Claim 10, with respect to the computer-readable storage medium by the subject-matter of the alternative, independent Claim 11 and with respect to the motor vehicle by the subject-matter of the alternative, independent Claim 12.

Advantageous configurations, further developments and variants are the subject-matter of the subclaims.

The advantages set out in terms of the method and configurations are to be transferred analogously to the computer program product, the computer-readable storage medium as well to the motor vehicle, and vice versa.

In concrete terms, the object targeted at the method is achieved by a method for planning a trajectory of a driving maneuver of a motor vehicle. The motor vehicle is in particular an autonomously driving motor vehicle with an autonomous driving program.

The method has the steps of:
1) evaluating a current driving situation;
2) ascertaining an adapted driving maneuver in the form of a trajectory on the basis of the evaluated driving situation;
3) calculating a number of working points of the trajectory on the basis of the evaluated driving situation and the ascertained driving maneuver;
4) discretizing the current surroundings information and/or vehicle information at each of the working points of the trajectory;
5) selecting and integrating relevant surroundings data for each working point on the basis of domain-specific information;
6) linearizing the selected and integrated surroundings data;
7) using the linearized surroundings data in order to formulate a QP model;
8) solving the QP model by means of a QP solver; and
9) repeating steps 1) to 8) on the basis of a convergence of the solution, wherein upon repeating steps 1) to 8), the solution of the QP solver is taken into consideration.

In the first step, the motor vehicle's own driving situation is initially evaluated by checking, for example, the environment of the motor vehicle for further road users, also referred to as TPOs (Traffic Participant Objects). In other words, the current traffic scenario around the motor vehicle is determined and evaluated, for example in terms of a distance from a TPO driving ahead or in terms of a TPO driving next to the motor vehicle, which is in particular of importance during a desired lane change.

Furthermore, however, vehicle-specific parameters can also contribute to the evaluation of the current driving situation in the first method step. Such vehicle-specific parameters can, for example, be a set driving mode (Economy or Sport) or a general instruction to the autonomous driving program in that the latter is to pursue a defensive and fuel-saving or, on the contrary, a sporty driving style.

An adapted driving maneuver in the form of a trajectory is then ascertained on the basis of the current driving situation ascertained and evaluated above.

A number of working points along the trajectory are subsequently calculated. Depending on the driving maneuver to be planned, 10 or more working points can be calculated here. For example, during a lane change maneuver, the first working point starts at the current position of the motor vehicle and the last working point “lies” on the lane to which the motor vehicle is to change.

In the next step, each working point is discretized along the trajectory. This means that at each working point, the current driving situation and, above all, the surroundings information are appraised to ensure they are up-to-date, that is to say at the respective point in time of the working point. In the event that, for example, a TPO is no longer in the environment of the motor vehicle, this circumstance is taken into consideration and included in the trajectory planning.

Subsequently, the actual core of the method according to the present disclosure is carried out. As a consequence, merely relevant surroundings data to each working point is selected and integrated on the basis of domain-specific information. The term “domain-specific information” can be understood to be information regarding the motor vehicle, the environment of the motor vehicle and in particular regarding the current driving situation, which help during trajectory planning to improve or even establish the convexity, that is to say the ability to solve the problem. In this case, recourse can be had, for example, to already known traffic scenarios, in order to merely take the relevant information into consideration. If, for example, the motor vehicle merely has to follow one lane and such a trajectory has to be planned, all of the TPOs which do not affect the motor vehicle's lane, that is to say the ego lane, can be neglected. That is to say that the priority is to also include the vehicle driving ahead in the planning in order to prevent tailgating. Such information can, for example, also be included, in the form of the domain-specific information, in this step during the trajectory planning. In other words, the trajectory planning is supported by the additional domain-specific information so that information which is not needed is deleted and, consequently, the problem to be solved becomes easier or even solvable in the first place.

The selected and integrated surroundings data already mentioned above are used in the next steps in order to formulate a QP model. To this end, the surroundings data and the vehicle model are initially linearized.

The QP model is subsequently solved by means of a QP solver. This is in particular made possible by the fact that, since the problem to be solved and the associated cost function have been simplified by eliminating constraints which are not to be taken into consideration due to the additional domain-specific information, they can be solved with a standard QP solver.

In the last step of the method, an analysis of the solution of the problem is carried out in terms of a convergence. In other words, an analysis is carried out as to whether a renewed discretization of the environment results in a similar QP formulation and, therefore, a similar QP solution. That is to say that a convergence analysis is carried out in terms of the problem formulation and the problem solution. That is to say that the solution obtained constitutes the solution of the non-linear optimization problem, provided that it lies within a local region of the performed approximations. Otherwise, the sequence must be repeated with an updated evaluation of the vehicle movement. The objective of the repetition is to achieve convergence of the linearized and non-linear equations.

If this is not the case, the preceding steps are repeated. That is to say, SQP-based trajectory planning is consequently carried out.

In principle, the task of non-linear general-purpose solvers is to solve generic problems. The modeling necessary for this by continual functions and mixed integers lacks the possibility of heuristic appraisal, which is necessary in order to solve the problem of trajectory planning within the framework of optimization. The problem of “getting stuck” in local minima in the case of discrete decisions (mixed-integer problems) is widely described in the literature.

This problem is countered by the method described above in that the domain-specific information, also referred to below as domain-specific heuristics, is implemented according to the present disclosure in the SQP algorithm. Within the meaning of this application, the term “heuristics” can generally be understood to be knowledge of driving functions of the motor vehicle.

This approach leads to a special SQP-based solver for trajectory planning by using the indicated heuristics, that is to say knowledge of driving functions, within the framework of embedded utilization.

For this purpose, heuristics are integrated into the SQP algorithm, in order to split up the non-convex and non-linear problem of the trajectory planning into sequential, locally precise and convex quadratic programs which can be solved by modern QP solvers.

The core of the method according to the present disclosure is, consequently, an SQP-based, non-linear solver which utilizes domain-specific heuristics. In addition, each discretization step is individually treated in order to select the best suited discretization without generalizing the entire trajectory.

The modeling of the problem as a linear quadratic program requires the formulation of all of the mathematical functions as linear or quadratic equations. As an advantage, a modern QP solver can be used in order to solve the optimization problem quickly and reliably as well as with simple means.

The method according to the present disclosure uses, inter alia, the heuristics described below in the embodiments as well as a model of the vehicle dynamics in order to estimate the vehicle movement for a specific time horizon. In detail, the time horizon for which the trajectory is to be planned must be discretized for a certain number of individual steps. The estimated vehicle states for each discretization step are used as working points for the following approximations. The static and dynamic surroundings data, as already described, are also individually discretized for each working point. This is carried out, for example, at a time interval of 50 ms-150 ms, such as every 100 ms.

In addition, all of the non-linear equations are linearized at the estimated operating points. The linear quadratic program can, consequently, be set up and solved with the linearized equations and discretized surroundings data.

In an embodiment, one or more of the following heuristics selected from:
assessing the current driving situation in order to recognize suitable maneuvers;
adapting the vehicle parameters on the basis of the assessed driving situation;
selecting or adapting a driving mode and/or a drive mode of the motor vehicle;
   is/are used as the domain-specific information.

In this case, the term “assessing the current driving situation” can be understood to mean that it is, for example, checked whether the motor vehicle's current lane (also referred to as the ego lane) and/or the adjacent lanes are free or are occupied by other TPOs. This is carried out at each working point. Furthermore, it is likewise checked whether an evasion within the meaning of a lane change is or will possibly be required. Furthermore, scene variations are also taken into consideration in order to make use of the possibility of changing surroundings. In summary, both a spatial component and the dynamics of the motor vehicle in each working point (from the spatial and temporal point of view) are, consequently, checked and taken into consideration.

Within the meaning of this application, the heuristics of adapting the vehicle parameters on the basis of the assessed driving situation can be understood to mean that, for example, in the case of the evasive maneuver described above, driving restrictions of the motor vehicle are removed or increased or decreased for a short time. In this case, the term “driving restrictions” can be understood to mean a set or predefined maximum speed or a predefined or set distance from the TPO driving ahead. Thus, it can be necessary, for example for the mentioned lane change, to increase or to exceed a speed limit and/or to fall below a predefined distance from the front TPO for a short time, so that the motor vehicle can turn into a free space on the adjacent lane.

In connection with this, a driving mode and/or a drive mode of the motor vehicle are consequently also taken into consideration and used during the planning of the trajectory.

The following list of examples of driving modes is not exhaustive:
Economy (very economical driving)
Comfort (normal driving mode)
Sport (sporty driving).

The following list of examples of drive modes is not exhaustive:
energy-efficient
electric
only with combustion engine
specific mode, e.g., high performance for active filter regeneration in the case of vehicles having a combustion engine.

In a further embodiment, the vehicle parameters are ascertained on the basis of a vehicle model, in particular on the basis of a dynamic one-lane model. In this case, in particular the mechanical and physical parameters and properties of the motor vehicle are taken into consideration. This embodiment is based on the idea that, in principle, the trajectory for the motor vehicle “must be drivable” for purely physical and technical reasons. For this reason, further accuracy and optimization of the planned trajectory are achieved with this embodiment since, as a result, trajectories for this motor vehicle, which cannot be driven physically and/or mechanically, are not taken into consideration. In particular, the dynamic one-lane model is based on the fact that the physical and mechanical properties such as, for example, the motor vehicle's accelerating power, cornering properties due to the wheelbase or braking performance are to be indicated in the form of kinematic equations which are implemented in order to be taken into consideration in the method.

According to an embodiment, the respective relevance of other road users to the driving maneuver in a longitudinal direction based on an estimated position of the motor vehicle is used in order to ascertain the relevant surroundings data. In this case, a preselection is made as to which dynamic objects are to be taken into consideration in the longitudinal direction, on the basis of the estimated vehicle positions (operating points) on the road. In this way, the number of equations needed for the object observations remains constant and reduces the duplication of constraints which could negatively influence the convexity of the underlying QP.

In a further development, the respective relevance of other road users to the driving maneuver in a transverse direction based on an estimated position of the motor vehicle is used in order to ascertain the relevant surroundings data. In this case, it is assessed which dynamic object is relevant on the basis of the estimated vehicle positions (operating points) on the road in a time step. In doing so, the approach scales from simple considerations such as blocking the adjacent lane in this time step up to more advanced geometry considerations.

Furthermore, according to an embodiment of the method, a road space available for the driving maneuver is also used in order to ascertain the relevant surroundings data and, consequently, in order to optimize the trajectory planning. This consequently takes into consideration the question of whether the road space is limited, for example by road markings or dynamic or static objects or any information which is independent of the time or dependent on the time (e.g., through traffic restriction depending on the time of day).

In order to determine objects between two vehicle positions, these two vehicle positions are usually appraised. As a general rule, the process of taking such objects into consideration requires an increase in the scanning rate, which leads to a change in the size of the underlying QP model. In an embodiment, in order to decouple this, the method has the steps of:
using heuristics in order to recognize at least one object between two working points; and
modeling and adding the recognized at least one object to the formulated QP model.

According to an embodiment, vehicle-internal entities and/or vehicle-external entities are used for the provision of the current driving situation and/or the current surroundings information. The vehicle-internal entities can preferably, but not exclusively, be sensor units or sensor systems such as, e.g., cameras, radar sensors or lidar sensors arranged in or on the motor vehicle. In general, all of the “information-supplying” elements and/or units of the motor vehicle are deemed to be a vehicle-internal entity within the meaning of this application. Consequently, the vehicle-internal navigation map is also one of the vehicle-internal entities. Alternatively or additionally, external entities can also be used for the evaluation of the current driving situation and/or the current surroundings information. Within the meaning of this application and in contrast to the vehicle-internal entities mentioned above, the term “vehicle-external entities” can be understood to mean all of the entities which are located outside the motor vehicle, but can provide information regarding the current driving information and/or surroundings. A so-called “intelligent parking garage” can be indicated as an example of such an external entity. Such parking garages include cameras or camera systems as well as various different sensors, with the aid of which the current position, speed and/or a current environment of the motor vehicle and/or further road user can be ascertained. This information is then made available to the trajectory planner. Within the meaning of this application, the term “vehicle-external entities” can also be understood to mean, for example, information which is provided and transmitted by other road users and/or by occupants of the motor vehicle (e.g., position signal of a smartphone or map data, etc.) and/or the surrounding infrastructure (e.g., surveillance cameras).

Alternatively or additionally, the electronic control unit of the motor vehicle as well as, in particular, in a motor vehicle driven by an electric motor, the electric powertrain (e.g., the powertrain control module) can, furthermore, be used in order to especially provide current vehicle information.

In an embodiment of the method, the planning of the trajectory has combined planning of a longitudinal trajectory and a lateral trajectory. Compared to known methods, this embodiment makes possible a combined method for longitudinal and transverse pathways, in which planning is modeled with the model-predictive planning approach by modeling the complex non-linear problem of automated driving into a point-discretized QP problem which is solved in a resource-efficient manner by a standard QP solver.

In concrete terms, the object with respect to the computer program product is achieved by a computer program product having commands which, when the program is run by a computer, prompt the latter to execute the method described above.

In concrete terms, the object with respect to the computer-readable storage medium is achieved by a computer-readable storage medium having commands which, when it is run by a computer, prompt the latter to execute the steps of the method described above.

In concrete terms, the object with respect to the motor vehicle is achieved by a motor vehicle, wherein the vehicle has means for executing the method described above. The motor vehicle may be an autonomously driving motor vehicle or a motor vehicle which is configured for autonomous driving.

### BRIEF DESCRIPTION OF THE DRAWINGS

An example embodiment of the present disclosure is explained in greater detail below on the basis of the figures which are, in part, extremely simplified depictions, wherein:

FIG. 1 shows a sketched block diagram in order to depict a basic sequence of driving maneuver planning and control on the basis of the planning;

FIG. 2 shows a simplified block diagram of the method according to the present disclosure;

FIG. 3 shows a sketched scenario of a driving maneuver in the form of a lane change; and

FIG. 4 shows the sketched scenario from FIG. 3 having depicted working points.

Components having the same effect are constantly depicted in the figures with the same reference numerals.

### DETAILED DESCRIPTION

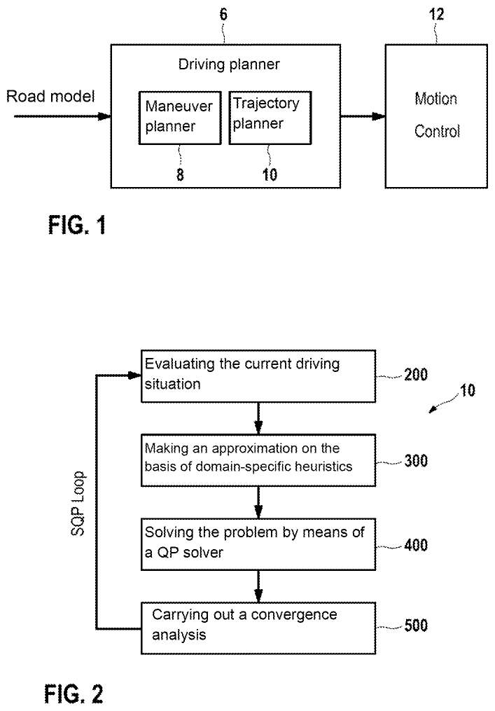

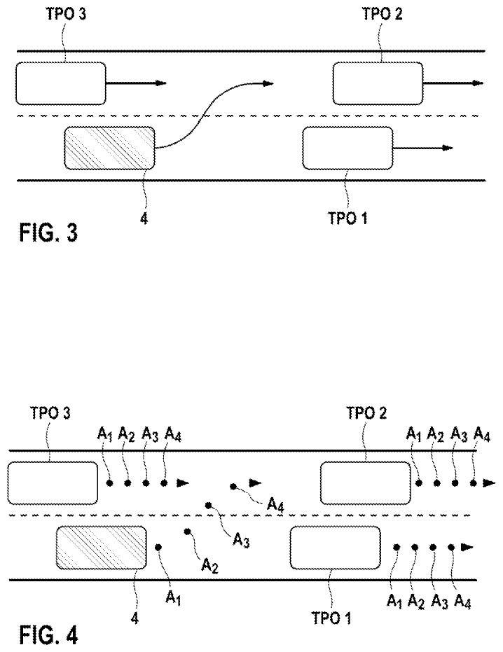

The basic sequence of driving maneuver planning and control for a motor vehicle 4 (cf. FIGS. 3+4) is depicted in FIG. 1. In this case, a detailed representation and description are dispensed with. FIG. 1 serves to illustrate the basic classification of the present disclosure in the planning sequence of the driving maneuver to be planned.

As can be seen in FIG. 1, a driving planner 6 is provided which obtains a so-called road model which has, by way of example, information regarding the course of a road, as an input signal. In addition, a list and, therefore, information regarding objects located within the environment of the motor vehicle 4 can additionally be fed into the driving planner 6 as the input signal. The objects can, for example, be other road users or road boundaries.

The driving planner 6 has a maneuver planner 8 and a trajectory planner 10. The maneuver planner 8 is set up to evaluate whether a driving maneuver is necessary on the basis of the information of the input signal and, on the basis of its evaluation, creates a maneuver request for the trajectory planner 10. Within the meaning of this application, the term “driving maneuver” can be understood to be standard maneuvers in road traffic such as, for example, an evasion, a lane change, or following another vehicle in one's own lane. This also covers other conceivable driving maneuvers which are generally required to avoid a collision or an accident.

The requested driving maneuver, for example a lane change, is then transmitted to the trajectory planner 10 as the input signal. A trajectory which the motor vehicle is to “set off on” in order to execute the requested driving maneuver is planned there on the basis of the existing information and further information which will be described below in even more detail. Once the trajectory has been planned, this is transmitted to the motion control module 12. The motion control module 12 then issues the necessary control commands for the execution of the trajectory to the individual components of the motor vehicle 4. With regard to the indicated example of the lane change, a steering command is given by the motion control module 12 to the steering as well as, possibly, a command to accelerate or brake the motor vehicle 4 in order to perform the lane change.

FIG. 2 shows a sketched block diagram of the method according to the present disclosure within the trajectory planner 10.

The trajectory is planned in a first fundamental step by an evaluation 200 of the current driving situation. In this case, it is determined whether and how many other road users are in the immediate vicinity of the motor vehicle 4. In this case, the term “immediate vicinity” can be understood to be the environment of the motor vehicle, which is relevant to the requested driving maneuver. This can vary depending on the requested driving maneuver. In the case of the example of the lane change, the immediate vicinity of the motor vehicle is limited to the road users located immediately in front of, behind and next to the motor vehicle, that is to say the immediate environment.

In addition, information regarding the motor vehicle is, however, also used in this method step for the evaluation. Thus, it is taken into consideration which driving mode the motor vehicle is in at that moment and also which physical and/or mechanical limits of the motor vehicle, e.g., maximum steering angle or accelerating power, are to be taken into consideration during the planning of the trajectory.

Once the current driving situation has been evaluated sufficiently, an approximation 300 is made on the basis of domain-specific heuristics, and the problem to be solved, on which the planning of the trajectory is based, is formulated in a next step. In this case, the trajectory to be planned is split into a number of working points A₁-A₄ (cf. FIG. 4). In this case, the surroundings situation (Where is the motor vehicle at the moment?-How are the other road users behaving compared with the previous working point?) is evaluated at each working point A₁-A₄, and the formulation of the QP is adapted accordingly.

According to the present disclosure, in this step, surroundings information which is not needed is reduced on the basis of the domain-specific heuristics. In this case, recourse is had to domain-specific knowledge, e.g., knowledge of certain traffic situations in which the motor vehicle has already been. The result of this is that the problem to be solved by the trajectory planner 10 is simplified. With reference again to the aforementioned example of the lane change, using the domain-specific heuristics can mean that—as long as the motor vehicle 4 is still in its current lane—the trajectory planner 10 merely takes other road users in its lane into consideration for the planning of the trajectory. As soon as the motor vehicle 4 has then changed to the neighboring lane or has carried out at least half of the lane change, only the other road users on the “new” lane are to be taken into consideration for the trajectory planning. In other words, according to the present disclosure, the domain-specific heuristics consequently help to simplify the problem to be solved.

Consequently, the problem which has been “simplified” on the basis of the domain-specific heuristics can be solved by a QP solver in a next method step 400.

Subsequently, a convergence analysis is carried out in a further step 500. In this case, it is checked whether a sufficient convergence of the problem has been achieved and, consequently, the planned trajectory is sufficient to carry out the requested driving maneuver. If this is the case, the planned trajectory, as already indicated in the explanations regarding FIG. 1, is transmitted to the motion control module 12 as an input signal. If, however, it is determined that a convergence is not yet sufficient, the method steps are performed again in a further sequence in order to attain a more precise convergence. In this case, the previously achieved solution as well as, additionally, further domain-specific heuristics are also included.

In summary, the method according to the present disclosure consequently forms an implementation of domain-specific heuristics in an SQP-based problem which is individually evaluated at each of the created working points A₁-A₄ and can be solved by means of a standard QP solver.

The example of the lane change which has already been used above to explain the method is explained more precisely below in FIGS. 3 and 4.

FIG. 3 shows a segment of a two-lane road on which the motor vehicle 4, which is depicted in a hatched manner, is moving in a direction of travel (towards the right in the image plane). Further road users TPO1, TPO2, TPO3, . . . , TPOn are additionally depicted on the road. In this case, n stands for a positive natural number which is intended to represent the open, but maximum number of road users. For the sake of simplicity and clarity, the following explanations always relate to merely three further road users TPO1, TPO2, TPO3, which is not, however, to be understood to be a restriction of the method according to the present disclosure.

The directions of travel of the further road users are each depicted by arrows. The same scenario is depicted again in FIG. 4. However, the individual working points A₁-A₄ of the approximated trajectory are depicted in FIG. 4. In this case, for the sake of simplicity, merely four working points A₁-A₄ are depicted for each road user, which—viewed from the respective object and in the direction of the arrow—each have a working point A₁-A₄ with corresponding information regarding the environment and/or which represent the driving situation and/or the vehicle itself at the respective working point A₁-A₄. In this case, as already explained in detail above, the information of each working point A₁-A₄ includes for example, but not exclusively, a speed and/or an acceleration and/or also so-called meta information regarding the vehicle, e.g., the vehicle type, as well as the time and/or the position. Consequently, it goes without saying that if the working point A₁ in the ego trajectory is appraised, the respective working point A₁ of TPO1, TPO2 and TPO3, etc. is also appraised.

The planned trajectory, here the lane change, of the motor vehicle 4 is likewise illustrated on the basis of the depicted curved arrow. Within the framework of the method according to the present disclosure, all three further road users TPO1-TPO3 are taken into consideration, and vehicle-internal information of the motor vehicle is taken into consideration for the evaluation of the current driving situation.

Without the domain-specific heuristics, all of the information and, consequently, all of the information regarding the other road users TPO1-TPO3 would be taken into consideration in each working point A₁-A₄ (cf. FIG. 4), which, on the one hand would lead to a more complex problem and, consequently, on the other hand, to an increase in the planning and, therefore, computational outlay.

Thanks to the implementation of the domain-specific heuristics, the motor vehicle 4 or the trajectory planner 10 now takes into consideration, at the start of the lane change, that is to say when the motor vehicle is still located in its current, “old” lane, merely the road users which are likewise in this lane, that is to say merely the road user driving ahead, TPO 1. The other road users TPO 2, TPO 3 and the information regarding these road users are still not (yet) taken into consideration at these working points A₁-A₄. As soon as the motor vehicle 4 has now at least partially crossed the center line, the trajectory planner 10 ascertains, by virtue of the domain-specific heuristics and from the surroundings, the information that, at the now following working points A₁-A₄, it merely has to take the road users which are in the “new” lane, that is to say the road users TPO2 and TPO3 here, into consideration in the further planning. Whether the other road user TPO1 then brakes, accelerates, or turns off is of secondary importance for the planning of the trajectory.

Consequently, the additional information helps the trajectory planner 10 in simplifying the problem to be solved by eliminating irrelevant constraints, so that the problem can be solved by a QP solver. This can be summarized as the convexification of the QP.

That is to say that, in summary, it can be stated that the challenge for trajectory planning described above can be formulated as a nonlinear optimization problem. Physical and safety-related limits can be formulated as constraints for this problem. The objective of this optimization problem is to calculate the extremes (e.g. minima) of a target function (also referred to as the cost function).

The invention is not limited to the exemplary embodiment described above. Rather, other variants of the invention can also be derived from this by a person skilled in the art without departing from the subject matter of the invention. Furthermore, all of the individual features described in connection with the exemplary embodiment can in particular be combined with one another in other ways without departing from the subject matter of the invention.

### LIST OF REFERENCE NUMERALS

4 Motor vehicle
6 Driving planner
8 Maneuver planner
10 Trajectory planner
12 Motion control module
A₁-A₄ Working points
TPO1 Further road user
TPO2 Further road user
TPO3 Further road user
200 Evaluating the current driving situation
300 Making an approximation on the basis of domain-specific heuristics
400 Solving the problem by means of a QP solver
500 Carrying out a convergence analysis

1. A method for planning a trajectory of a driving maneuver of a motor vehicle, the method comprising:
1) evaluating a current driving situation;
2) ascertaining an adapted driving maneuver on the basis of the evaluated driving situation;
3) calculating a number of working points of the trajectory on the basis of the evaluated driving situation and the ascertained driving maneuver;
4) discretizing at least one of current surroundings information and/or vehicle information at each of the working points of the trajectory;
5) selecting and integrating relevant surroundings data for each working point on the basis of domain-specific information;
6) linearizing the selected and integrated surroundings data;
7) using the linearized surroundings data in order to formulate a QP model;
8) solving the QP model by a QP solver;
9) repeating 1) to 8), on the basis of a convergence of the solution of the QP model, wherein upon repeating 1) to 8), the solution of the QP solver is taken into consideration.

2. The method according to claim 1, wherein one or more of the following heuristics selected from:
assessing the current driving situation in order to recognize suitable maneuvers;
adapting vehicle parameters on the basis of the assessed driving situation; and
selecting or adapting at least one of a driving mode or a drive mode of the motor vehicle;
wherein the one or more of the heuristics selected is/are used as the domain-specific information.

3. The method according to claim 2, wherein the vehicle parameters are ascertained on the basis of a vehicle model.

4. The method according to claim 1, further comprising ascertaining the relevant surroundings data using a respective relevance of other road users to the driving maneuver in a longitudinal direction based on an estimated position of the motor vehicle.

5. The method according to claim 1, further comprising ascertaining the relevant surroundings data using the respective relevance of other road users to the driving maneuver in a transverse direction based on an estimated position of the motor vehicle.

6. The method according to claim 1, further comprising ascertaining relevant surroundings data by using an available road space for the driving maneuver.

7. The method according to claim 1, further comprising:
using heuristics in order to recognize at least one object between two working points; and
modeling and adding the recognized at least one object to the formulated QP model.

8. The method according to claim 1, further comprising providing at least one of the current driving situation or the current surroundings information using at least one of vehicle-internal entities of the motor vehicle or vehicle-external entities.

9. The method according to claim 1, wherein the planning of the trajectory has combined planning of a longitudinal trajectory and a lateral trajectory.

10. A computer program product having commands which, when the program is run by a computer processor, prompt the computer processor to execute the method according to claim 1.

11. A non-transitory computer-readable storage medium having commands which, when run by a computer processor, prompt the computer processor to execute the method according to claim 1.

12. A motor vehicle, in particular an autonomously driving motor vehicle, having means for executing the method according to claim 1.

13. The motor vehicle of claim 12, wherein the motor vehicle comprises an autonomously driving motor vehicle.

14. The method according to claim 2, wherein the vehicle parameters are ascertained on the basis of a dynamic one-lane model.
